(19) United States
(12) Patent Application Publication
(10) Pub. No.: US 2026/0164217 A1
(43) Pub. Date: Jun. 11, 2026

(54) Dynamic Groups for Network Function Services

(71) Applicant: Telefonaktiebolaget LM Ericsson (publ), Stockholm (SE)

(72) Inventors: Emiliano Merino Vazques, Madrid (ES); Juan Manuel Fernandez Galmes, Madrid (ES); Jingrui Tao, Guangzhou (CN); Ping Chen, Shanghai (CN); Maria Cruz Bartelome Rodrigo, Madrid (ES)

(21) Appl. No.: 18/707,484

(22) PCT Filed: Dec. 9, 2022
(86) PCT No.: PCT/EP2022/085080

§ 371 Date: May 3, 2024

(30) Foreign Application Priority Data
Dec. 10, 2021 (EP) 21383126.6

(51) Int. Cl. H04W 4/08; H04W 8/18

(52) U.S. Cl. CPC H04W 4/08; H04W 8/186

(57) ABSTRACT

Methods and apparatus are described to allow a MTC provider or other AF to specify a target group of UEs without the need to predefine the group or give the target group a EGI. This objective is achieved by storing additional information in a UE-specific context or session context and introducing a new scope indication for the “any UE” target identifier in the service requests or other service messages. The scope indication comprises a matching criteria linked to a context parameter stored by the network node as part of a UE-specific context or session context. The scope indication is applied to the “any UE” target identifier. When a service request or other service message having a target identifier indicating “any UE” is received, the NF can compare the information in the scope indication to the linked context parameter for each UE to determine if it is a target UE. The requested service is then provided for one or more UEs identified as target UEs.

### TECHNICAL FIELD

The present disclosure relates generally to network functions (NFs) in a core network of a wireless communication network and, more particularly, to techniques for providing NF services to ad hoc groups.

### BACKGROUND

The Internet of Things (IoT) is a global network of interconnected devices (e.g., robots, controllers, sensors, and vehicles) that collect information about the use of the device or its environment and share that information with other interconnected devices. Virtually any device having an on/off switch can be connected to the Internet and communicate with other devices. The IoT has experienced rapid growth in the past decade and it is predicted reach 75 billion connected devices by 2025.

A special class of IoT devices are called Machine Type Communication (MTC) devices. MTC is a form of data communication that involves communication between devices without human interaction. A MTC device is a device equipped for MTC that communicates over the Internet or other wide area network (WAN) with a MTC server and/or other MTC devices.

The Cellular Internet of Things (cIoT) is a wireless technology for enabling MTC devices to communicate with the MTC server and other MTC devices over a wireless communication network, such as a Fourth Generation (4G) or Fifth Generation (5G) network. In cIoT, the wireless network serves as an access network to connect the MTC devices to the Internet. Using cIoT, a MTC operator can build a MTC network for providing various application services to other parties/companies. A classic example of an MTC service is meter reading. In this example, wireless utility meters (e.g., gas or power meter) are installed at the points of usage. The wireless meters wake up at certain times, e.g. once a month, to send the current meter readings to the utility operator. Another good example is fleet tracking. In this example, Global Positioning System (GPS) devices are installed in vehicles to allow fleet operator to track the location of their vehicles.

An exposure function (EF) is a functional entity, i.e., network function, within a wireless communication network that exposes services offered by the network to external applications (e.g., to MTC providers). One exemplary service offered by the wireless communication network is event notification. A MTC provider may want to receive notifications about certain events related to their MTC devices. As an example, the MTC provider may want to know when a MTC device moves outside a defined geographic area, or when the power level of the MTC device drops below a threshold. For event notifications, the EF receives a subscription from the MTC provider for events related to its MTC devices. Another exemplary service provided by the wireless communication network is over-the-air (OTA) configuration of MTC devices. This service allows the MTC provider to specify device configuration for MTC device that impact the device behavior. For example, a MTC provider may configure its MTC devices to report data on a particular schedule. The OTA configuration of MTC devices is used for both network configurations and behavioral configurations. For device configuration, the EF receives the configuration from the MTC provider for its MTC devices. When a MTC device registers with the network, the NF serving the MTC device can apply the appropriate configuration for the MTC device.

If an Application Function (AF) or Application Server (AS) belonging to a given MTC provider wants to subscribe to event notifications, or specify a behavioral configuration, that applies to all of its MTC devices, the MTC provider needs to define a group of MTC devices and assign an External Group Identifier (EGI) to the group. External groups are complex and cumbersome to use from a provisioning and management perspective. If a new MTC device is installed or deployed, in addition to provisioning the data for the MTC device, the operator must add the MTC device to the group so that the group information will be consistent. From the network perspective, the handling of EGIs is quite complex. The network is required to control and monitor the number of devices in each group, given that it is mandatory for the Uniform Data Management (UDM) function to return the number of devices when a configuration is applied to all devices in the group. The number of devices is required only when the AF needs to count the number of event reports (for event exposure) for each and every device. More recently, the MTC application servers/functions do not require such counting, since they only require an expiration time for the configuration, rather than a maximum number of reports, before the configuration is removed from the network. Another potential complication is that the Third Generation Partnership Project (3GPP) is adopting new provisions that authorize requests for a given MTC provider on a per-device basis. The per-device feature adds yet another piece of information to be consistent in the operator's network. If a device is associated with a certain MTC provider, the device also needs to be included in the corresponding EGI for the MTC provider.

It is apparent that when a large number of devices are owned by a certain MTC provider, the current mechanisms to manage the EGIs of them consistently is very inefficient in terms of signaling, management and processing.

### SUMMARY

One aspect of the present disclosure comprises techniques that allow a MTC provider or other AF to specify a target group of UEs without the need to predefine the group or give the target group a EGI. This objective is achieved by storing additional information in a UE-specific context (e.g., UE context or session context) and introducing a new scope indication for the “any UE” target identifier in the service requests or other service messages. The scope indication comprises a matching criteria linked to a context parameter stored by the network node as part of the UE-specific context. The scope indication is applied to the “any UE” target identifier. When a service request or other service message having a target identifier indicating “any UE” is received, the NF can compare the information in the scope indication to the linked context parameter for each UE to determine if it is a target UE. The requested service is then provided for one or more UEs identified as target UEs.

A first aspect of the present disclosure comprises methods implemented by a network node in a wireless communication network. In one embodiment, the method comprises receiving a service message including a target identifier set to a value indicating that any UE is targeted by a service request or notification comprised in the service message and a scope indication to be applied to the target identifier. The scope indication comprises a matching criteria linked to a UE-specific context parameter stored by the network node as part of a UE-specific context. The method further comprises determining, for each of one or more UEs served by the network node, whether the UE is a target UE by comparing the scope indication in the service message to the linked UE-specific context parameter stored as part of the UE-specific context. The method further comprises providing a service, particularly a service corresponding to the service request or notification, for one or more of the target UEs based on the determining.

A second aspect of the disclosure comprises a network node in a wireless communication network. In one embodiment, the network node is configured to receive a service message including a target identifier set to a value indicating that any UE is targeted by a service request or notification comprised in the service message and a scope indication to be applied to the target identifier. The scope indication comprises a matching criteria linked to a context parameter stored by the network node as part of a UE-specific context.

The network node is further configured to determine, for each of one or more UEs served by the network node, whether the UE is a target UE by comparing the scope indication in the service message to the linked UE-specific context parameter stored as part of the UE-specific context. The network node is further configured to provide a service, particularly a service corresponding to the service request or notification, for one or more of the target UEs based on the determining.

A third aspect of the disclosure comprises a network node in a wireless communication network. In one embodiment, the network node comprises communication circuitry configured to enable communication with other network nodes in the wireless communication network, and processing circuitry controlling the operation of the network node. The processing circuitry is configured to receive a service message including a target identifier set to a value indicating that any UE is targeted by a service request or notification comprised in the service message and a scope indication to be applied to the target identifier. The scope indication comprises a matching criteria linked to a context parameter stored by the network node as part of a UE-specific context. The processing circuitry is further configured to determine, for each of one or more UEs served by the network node, whether the UE is a target UE by comparing the scope indication in the service message to the linked UE-specific context parameter stored as part of the UE-specific context. The processing circuitry is further configured to provide a service, particularly a service corresponding to the service request or notification, for one or more of the target UEs based on the determining.

As will be contemplated by the skilled person, the mentioned service to be provided by the network node can, in the case of a notification comprised in the service message, simply be to forward or convey the notification to the one or more target UEs.

A fourth aspect of the disclosure comprises a computer program for a network node in a wireless communication network. The computer program comprises executable instructions that, when executed by processing circuitry in the network node, causes the network node to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

### BRIEF DESCRIPTION OF THE DRAWINGS

FIG. 1 illustrates network functions in a wireless communication network configured to implementing dynamic grouping as herein described.

FIGS. 2A and 2B illustrate a procedure for providing event notifications to an application function for UE group.

FIG. 3 illustrates a procedure for external parameter provisioning of an ad hoc group of UEs for an application function.

FIG. 4 illustrates an exemplary method implemented by a network function for providing a service to an ad hoc UE group for an application function

FIG. 5 illustrates a network function configured to provide a service to an ad hoc UE group for an application function.

FIG. 6 illustrates another embodiment of a network function configured to provide a service to an ad hoc UE group for an application function.

### DETAILED DESCRIPTION

Referring now to the drawings, an exemplary embodiment of the disclosure will be described in the context of a Fifth Generation (5G) wireless communication network. Those skilled in the art will appreciate that the methods and apparatus herein described are not limited to use in 5G networks but may also be used in wireless communication networks operating according to other standards.

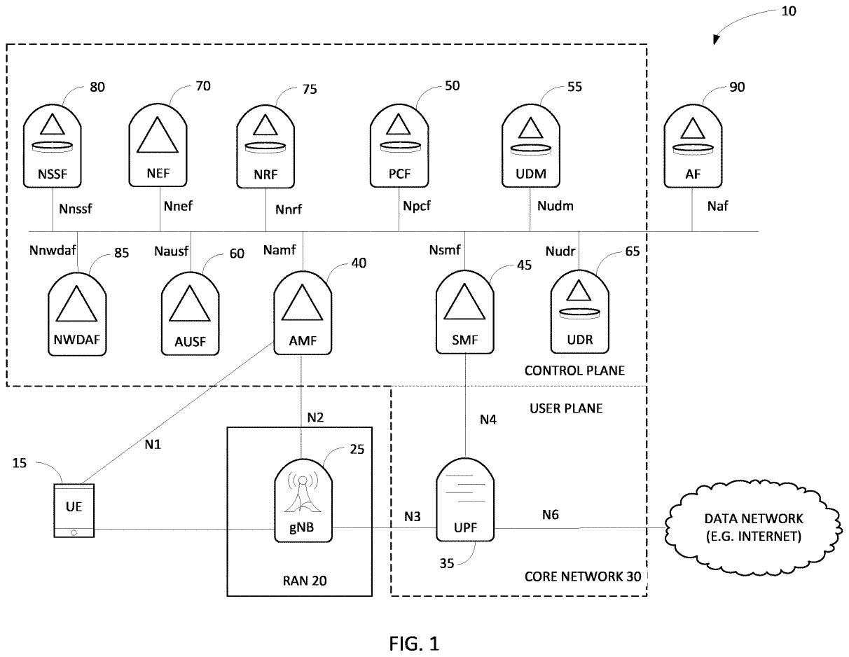

FIG. 1 illustrates a wireless communication network 10 according to one exemplary embodiment. The wireless communication network 10 comprises a radio access network (RAN) 20 and a core network 30 employing a service-based architecture. The RAN 20 comprises one or more base stations 25 providing radio access to UEs 100 operating within the wireless communication network 10. The base stations 25 are also referred to as gNodeBs (gNBs) in the 5G standards. The core network 30 provides a connection between the RAN 20 and other packet data networks, such as an IMS or the Internet.

In one exemplary embodiment, the core network 30 comprises a plurality of network functions (NFs), such as a User Plane Function (UPF) 35, an Access And Mobility Management Function (AMF) 40, a Session Management Function (SMF) 45, a Policy Control Function (PCF) 50, a Unified Data Management (UDM) function 55, an Authentication Server Function (AUSF) 60, a Unified Data Repository (UDR) 65, a Network Exposure Function (NEF) 70, a Network Repository Function (NRF) 75 and a Network Slice Selection Function (NSSF) 80. The core network 30 may additionally include a Network Data Analytics Function (NWDAF) 85 for generating and distributing analytics reports. These NFs comprise logical entities that reside in one or more core network nodes, which may be implemented by one or more processors, hardware, firmware, or a combination thereof. The functions may reside in a single core network node or may be distributed among two or more core network nodes. Also, the various function can also be implemented by virtual machines or containers in a cloud platform. The network 10 may further include one or more Application Functions (AFs) 90 providing services to the network and/or subscribers. The AFs 90 may be located in the core network 30 or be external to the core network 30.

It is noted that the mentioned network functions according to a 5G network herein may still be referred to as “network nodes”, even if they may generally be virtual functions, i.e. the term “network node” herein is meant to encompass also (virtualized) network functions. On the other hand, the term “network node” may herein still encompass traditional, not or only partly virtualized, network nodes.

In a conventional wireless communication network, the various NFs (e.g., SMF 45, AMF 40, etc.) in the core network 30 communicate with one another over predefined interfaces. In the service-based architecture shown in FIG. 1, instead of predefined interfaces between the network functions, the wireless communication network 10 uses a services model in which the NFs query the NRF 75 or other NF discovery node to discover other NFs and/or the services offered by them and communicate with each other.

Services offered by the NFs within the wireless communication network are exposed to external AFs 90 by the NEF 70. An AF 90 can query the NEF 70 to discover services offered by NFs within the wireless communication network. The AF 90 can make a request for services offered by an NF by sending a service request message to the NEF 70. As an example, The AF 90 may comprise an application server, referred to herein as an MTC server, for providing MTC services. The MTC server can send a service request to the NEF 70 to request a particular service offered by the AMF 40 or other network node. The service request includes a target identifier that identifies a target of the service request. Currently, three types of target identifiers are defined. The target identifier may identify a single UE 15, a group of UEs 15, or any UE 15. In this context, the “any UE” target identifier means all UEs served by a network node receiving the request. In the case of a UDM 55, the “any UE” target identifier indicates all UEs in the PLMN. In the case of the AMF 40, the “any UE” target identifier indicates all UEs served by the AMF 40.

The service requests received by the NEF 70 are distributed to the appropriate NFs in the wireless communication network. The NEF 70 will forward the service request received from the MTC server to the UDM 55, which will identify the AMFs 40 or other NFs serving the UEs identified in the service request. The service request is forwarded to all AMFs 40 managed by the UDM 55. In this manner, the service request is received by all AMFs 40 serving the UEs 15 identified by the target identifier.

When an MTC server would like to send a service request to the network targeting all UEs (e.g., MTC devices) belonging to the MTC provider, the MTC provider creates an external group including the UEs and assigns an External Group Identifier (EGI) to the group. The MTC provider informs the network about the group and provides the network with the EGI and a corresponding list of UEs in the group. When the MTC provider requested services for the group, it includes the EGI for the group as the target identifier in the service request message. Thus, external groups (i.e., groups defined outside the network) must be predefined before the EGI can be used to request services for a group of UEs.

As previously described, external groups are complex and cumbersome to use from a provisioning and management perspective. Maintaining consistency in group data across the network is difficult and requires a lot of signaling.

One aspect of the present disclosure comprises techniques that allow a MTC provider or other AF 90 to specify a target group of UEs without the need to predefine the group or give the target group an EGI. This objective is achieved by storing additional information in a UE-specific context, such as a UE context or session context and introducing a scope indication for the “any UE” target identifier in the service request. The scope indication comprises a matching criteria linked to a context parameter stored by the network node or network function as part of a UE-specific context. The scope indication is applied to the “any UE” target identifier. When a service request or other service message having a target identifier indicating “any UE” is received, the NF or network node compares the information in the scope indication to the linked context parameter for each UE to determine if it is a target UE. The requested service is then provided for one or more UEs identified as target UEs.

The techniques herein described are particularly useful to dynamically define groups of UEs belonging to a MTC provider. Of course, this is only one example of how the scope indication can be used and other applications are contemplated. For example, the technique can be applied to virtually any dynamic data, not only subscription data. For example, the same techniques can be applied to all UEs 15 with a certain Tracking Area Code (TAC) in the Permanent Equipment Identifier (PEI) (e.g. all Apple UEs 15, all Huawei UEs 15). As another example, the techniques can be applied to all UEs served by a specified network slice.

3GPP recently agreed to authorize requests for a given MTC provider on a per-UE basis. If MTC provider information and/or AF identifier (AF ID) are received in the request, the UDM 55 checks whether the MTC provider and/or the AF 90 is allowed to perform this requested operation for the UE 15; otherwise, the UDM 55 skips the MTC provider and/or AF authorization check. If the MTC provider information is provisioned per-UE, the technique can be used to dynamically create groups based on the MTC provider information.

When a UE 15 registers in 5GC network 10, the serving node or network function (e.g., AMF 40 in the case of 5GC) retrieves the 5G subscription data associated with the UE 15. New subscription data, generically called “MTC information” is included in the registration response. The MTC information includes the already defined MTC provider information, but can be extended to include other MTC information. The AMF 40 stores this new MTC information as part of the UE context. Later, when a given AF 90 or NEF 70 requires a service to be applied to all UEs 15 for a given MTC provider, it will include the existing “any UE” indication and the scope indication if the request is not intended all UEs 15 managed by the UDM 55, but only for a subset of UEs 15 matching the scope indication. When the scope indication comprises the MTC provider information, the scope of the “any UE” indication will be “all UEs 15 associated with or belonging to a given MTC provider.

When the UDM 55 receives the service request from the NEF 70, the UDM 55 detects the scope of the “any UE” and sends the scope indication to all appropriate serving nodes (e.g., AMFs 40) to indicate that the service will be applied to all UEs 15 registered in the receiving AMF 40 and having the MTC provider Information as received from UDM 55. The AMF 40 and UDM 55 require a negotiation (e.g. via supported-feature) prior to this, since the AMF 40 must support the “any UE scope” so that the request is applied only to those UEs 40. If AMF does not support the “any UE scope”, AMF will apply the request to all UEs, which is not the wanted behavior.

As an illustration, the scope indication can be used with subscriptions to event notifications for UEs belonging to the MTC provider. Thus, the MTC provider can, without defining a group in advance, subscribe to certain events for all UEs belonging to the MTC provider. The technique can also be applied to network configurations and behavioral configurations. The MTC provider can define a network configuration or behavioral configuration for all UEs belonging to the MTC provider. More generally, an event subscription may be regarded as a configuration so the techniques can be applied to any configuration of dynamic information.

In the case of network and behavioral configurations, all UEs 15 registering in the AMF 40 will inherit the configuration and the configuration is applied automatically to new UEs 15 that include the MTC information as part of the subscription data. If an already registered UE 15 is newly provisioned with MTC information, the UDM 55 will notify the change of 5G subscription data, which will trigger the AMF 40 to immediately start applying the configuration (as MTC information is received as part of subscription data). This process does not require extra provisioning or signaling across the different NFs (e.g. NEF 70).

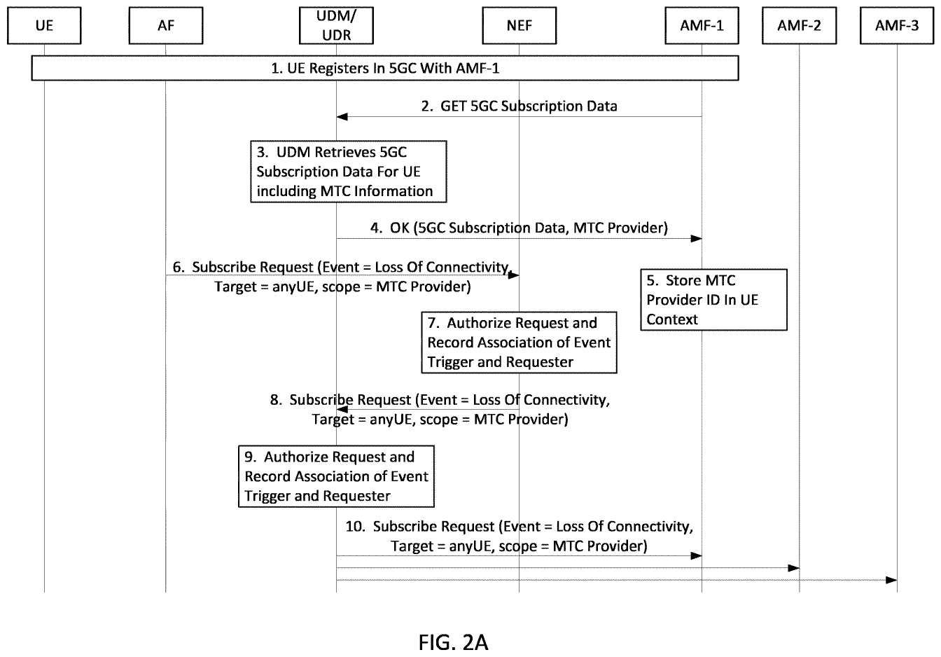

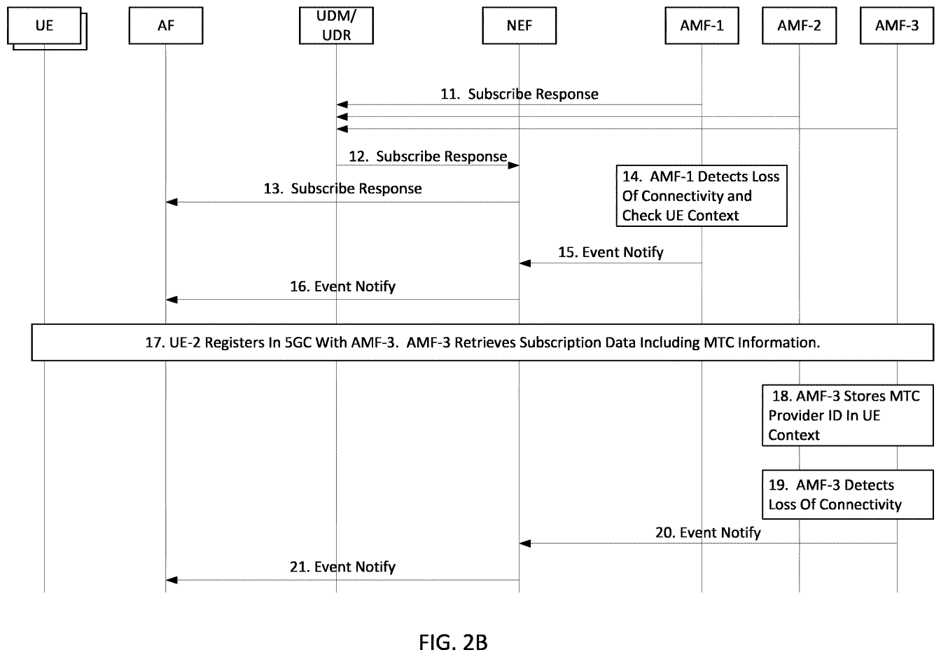

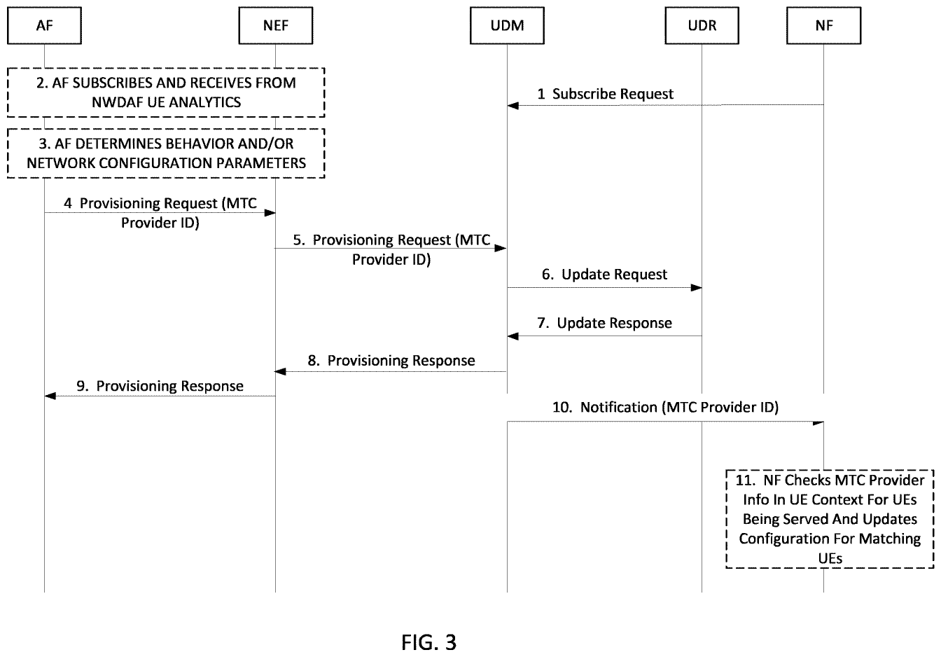

FIGS. 2A and 2B illustrate an exemplary procedure for subscribing to event notifications for a group of UEs 15 without the need to predefine the group. The procedure shown in FIG. 3 generally corresponds to the NEF service operations procedure shown in Section 4.15.3.2.3 of 3GPP TS. 223.502(v20 ). A UE 15 managed by the MTC application registers with the network and is served by an AMF 40, denoted AMF-1 in this example (1). The AMF 40 retrieves subscription information for the UE 15 from the UDM 55 (2-4). The subscription information received from the UDM 55 contains MTC provider information, which includes an identifier of the MTC provider (MTC provider ID). The AMF 40 stores the MTC provider ID as part of the UE context (5).

An MTC application sends a request (e.g., Nnef_EventExposure_Subscribe request) to the NEF 70 for event notifications for all UEs 15 managed by the MTC application (6). In this example, the MTC application requests notification when a managed UE 15 loses connectivity. The service request incudes a target identifier indicating the UEs 15 targeted by the request, and an event trigger indicating events for which notification is required. The request may optionally include an event filter to be applied to the event trigger. In this example, the target identifier indicates “any UE” and the event trigger indicates loss of connectivity. This is only one example event; the MTC application could subscribe to receive notifications for other events. The service request further incudes a scope indication to be applied to the target identifier. In this example, the scope indication comprises the MTC provider ID. The NEF 70 authorizes the request or the MTC provider and records an association of the event trigger and requester identity (7). If the request is authorized, the NEF 70 sends a subscription request (e.g., Nudm_EventExposure_Subscribe request) to the UDM 55 and provides the associated notification endpoint to the UDM 55 (8). The subscription request sent to the UDM 55 includes the target identifier, event list scope indication to the UDM 55 and provides the associated notification endpoint of the NEF 70 to the UDM 55. The UDM 55 authorizes the request records the association of the event trigger and the requester identity (9). In this example, the requested event (e.g., loss of connectivity) requires AMF 40 assistance so the UDM 55 sends a subscription request (e.g., Namf_EventExposure_Subscribe request) to all AMFs 40 in the PLMN and provides the notification endpoint to the AMFs 40 (10). The subscription request includes the “any UE” target identifier, the event trigger and the scope indication received from the NEF 70. The AMFs 40 answer with an acknowledgement of the subscription (11). After receiving the response from the AMFs 40, the UDM 55 sends a response to the NEF 70 confirming the subscription (12). The NEF 70, in turn, sends a response to the AF 90 confirming the subscription (13).

After the subscription is completed, AMF-1 detects that a registered UE 15 has lost connectivity (14). The AMF 40 checks the UE context for the UE 15 and, if there is “MTC information”, the AMF 40 also checks for active subscriptions to “any UE” and the indicated scope. If the scope indication in a subscription matches the MTC provider ID stored in the UE context, the AMF 40 send an event notification (Namf_EventExposure Notify) to the NEF 70 to report the event (15). The NEF 70 reports the event to the AF 90 by sending an event notification (Nnef_EventExposure Notify) (16). If the MTC provider ID stored in the UE context does not match the scope of any UE event configuration, the event is not reported.

After the subscription is made, a new UE 15 registers with the network and is served by AMF-3. The AMF 40 retrieves subscription information for the UE 15 from the UDM 55 as previously described. The subscription information received from the UDM 55 contains MTC provider information, which includes an identifier of the MTC provider (MTC provider ID). The AMF 40 stores the MTC provider ID as part of the UE context (18).

AMF-3 detects that a registered UE 15 has lost connectivity (19). The AMF 40 checks the UE context for the UE 15 and, if there is “MTC information”, the AMF 40 also checks for active subscriptions to “any UE” and the indicated scope. If the scope indication in a subscription matches the MTC provider ID stored in the UE context, the AMF 40 reports the event to the NEF 70 by sending an event notification. (20). The NEF 70 also sends an event notification to the AF 90 (21). If the MTC provider ID stored in the UE context does not match the scope of any UE event configuration, the event is not reported.

FIG. 3 illustrates an exemplary procedure for provisioning behavioral configurations for a group of UEs 15 belonging to a MTC provider without the need to predefine the group. The procedure shown in FIG. 3 generally corresponds to the NEF service operations procedure shown in Section 4.15.6.2 of 3 GPP TS. 223.502(v20 ). The AMF 40 or other NF sends a subscription request to the UDM 55 to receive UDM notifications whenever there is a subscription update (1). The subscription request (e.g., Nudm_SDM_Subscribe request) specifies “any UEs”. The AF 90 for an MTC provider optionally subscribes to and receives analytics from the NWDAF 85 (2). Based on the analytics, the AF 90 optionally determines behavior and/or network configuration parameters for UEs 15 managed by the AF 90 (3). The AF 90 sends a provisioning request (e.g., Nnef_parameterProvision_Create/Update/Delete request) to the NEF 70 (4). The provisioning request includes a target identifier indicating the UEs 15 targeted by the request and indicates one or more parameters to be created, updated or deleted. In this example, the provisioning request indicates “any UE” and the provisioned parameters. In contrast to the prior art, the provisioning request does not need to include an EGI for the UE group. Instead, the provisioning request includes a scope indication indicating the MTC provider ID. If the AF 90 is authorized by the NEF 70 to provision the parameters, the NEF 70 sends a provisioning request (e.g., Nudm_parameterProvision_Create/Update/Delete request) to the UDM 55 (5). The provisioning request includes the provisioned parameters, a NEF reference ID, and scope indication with MTC provider information. If the AF 90 is authorized by the UDM 55 to provision the parameters, the UDM 55 updates the subscription data according to the provisioned parameters received from the NEF 70 and sends an acknowledgement to the NEF 70 (6-8). The NEF 70 then sends an acknowledgement to the AF 90 indicating the outcome of the provisioning request (9). When the subscription data is updated, the UDM 55 sends a notification (e.g., Nudm_SDM_Notification message) to the subscribing AMF 40 (10). The notification includes a target identifier indicating “any UE” and the provisioned parameters. The notification further includes a scope indication to be applied to the target identifier, which in this example is the MTC provider ID. The AMF 40 checks the MTC provider information stored in the UE context for UEs 15 served by the AMF 40 and updates the configuration for UEs 15 matching the scope indication (11).

FIGS. 2A, 2B and 3 illustrate how the dynamic grouping can be used to support event subscriptions, network configuration and behavioral configuration for UEs 15 belonging to a particular MTC provider without the need to predefine a group. The concept of a scope indication applied to the “any UE” target indicator” is introduced so, instead of an event configuration, network configuration or behavioral configuration being applied to all UEs 15 in the Public Land Mobile Network (PLMN) (which is the current definition in 3GPP for the “any UE” indication) with no possibility for filtering out UEs 15, the scope indication allows service requests to be more accurate and granular. MTC provider ID has been used to describe the concepts, but those skilled in the art will appreciate that other scope criteria could be used. Generally, the technique can be applied to virtually any subscription data for a given UE 15, or any dynamic data (e.g., International Mobile Equipment Identifier (IMEI)) that is saved in the UE-specific context. For example, the same techniques can be applied to all UEs 15 within a certain TAC in the PEI (e.g. all Apple UEs 15, all Huawei UEs 15). As another example, the techniques can be applied to all UEs 15 served by a specified network slice.

The techniques herein described reduce network signaling because there is no need of individual signaling for each UE group member. It also reduces substantially the complexity for the provisioning system because the management of EGIs which is very challenging is not necessary. The techniques avoid inconsistencies in the network when it comes to the information to be provisioned with the simple and unique provisioning of the MTC provider information as part of the MTC data in the 5G subscription data. The techniques further allows the network to perform a self-management of such information to allow different things, e.g. an operator might deregister/reauthenticate via Operation s and Maintenance (O&M) all UEs 15 associated with to a certain MTC provider in a given AMF 40, or in the whole network

An alternative solution can be based on the usage of EGIs and keeping the consistency across the UE provisioned data and the EGI membership data (UE members) synchronized in an automated manner, but this solution is not recommended due to the complexity in the handling of the EGI across the network. For every MTC provider, an EGI should be created and maintained just to provide the means for AFs to operate/manage all their devices in an efficient manner. The network could end up with lots of groups of UEs 15 to be managed by the operator.

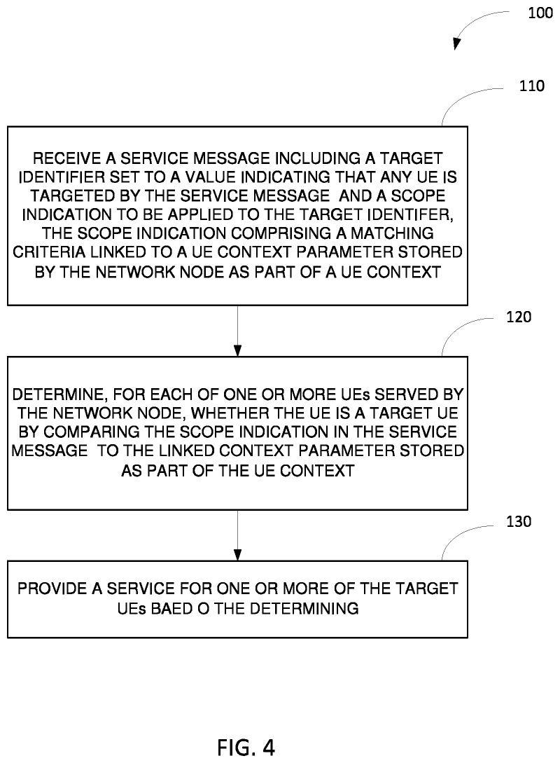

FIG. 4 illustrates an exemplary method 100 implemented by an AMF 40 or other network node in a wireless communication network. The AMF 40 receives a service message (e.g., service request or notification) including a target identifier set to a value indicating that any UE 15 is targeted by the service message and a scope indication to be applied to the target identifier (110). The scope indication comprises a matching criteria linked to a context parameter stored by the network node as part of a UE-specific context (e.g., UE context for AMF or session context for SMF 45). For each of one or more UEs 15 served by the AMF 40, the AMF 40 determines whether the UE 15 is a target UE 15 by comparing the scope indication in the service message to the linked context parameter stored as part of the UE-specific context (120). Based on the comparison, the AMF 40 provides a service for one or more of the target UEs 15 (130).

In some embodiments of the method 100, receiving the service message comprises receiving a subscription request for event notifications related to one or more events for the target UEs 15.

In some embodiments of the method 100, determining, for each of one or more UEs 15, whether the UE 15 is a target UE 15 is performed responsive to detection of an event specified by the subscription request.

In some embodiments of the method 100, providing the service for one or more of the target UEs 15 comprises sending an event notification responsive the detection of the event specified by the subscription request.

In some embodiments of the method 100, receiving the service message comprises receiving a notification indicating that a configuration parameter for one or more UEs 15 served by the network node (200, 300) has been changed.

In some embodiments of the method 100, determining, for each of one or more UEs 15, whether the UE is a target UE 15 is performed responsive to the notification.

In some embodiments of the method 100, providing the service for one or more of the matching UEs 15 comprises updating a configuration of one or more of the target UEs based on the configuration parameter.

In some embodiments of the method 100, the configuration parameter comprises a behavior parameter, and updating the configuration comprises updating a behavior configuration for the one or more target UEs 15.

In some embodiments of the method 100, the configuration parameter comprises a network configuration parameter, and updating the configuration comprises updating a network configuration for the one or more target UEs 15.

In some embodiments of the method 100, the scope indication comprises an identifier of an equipment provider.

In some embodiments of the method 100, determining, for each of one or more UEs served by the network node (200, 300), whether the UE 15 is a target UE comprises determining whether the equipment provider identifier provided in the scope indication matches equipment provider information stored in the UE context.

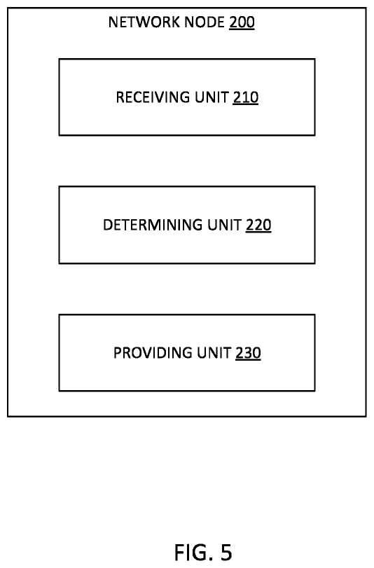

FIG. 5 illustrates the main functional components of a network node 200 configured to perform the methods as herein described. The network node 200 may, for example, comprise an AMF 40, SMF 45 or other NF that stores a UE-specific context. The network node 200 comprises a receiving unit 210, a determining unit 220 and a providing unit 230. The various units 210 230 can be implemented by hardware and/or by software code that is executed by one or more processors or processing circuits. The functions of the units 210 230 can also be implemented by virtual machines and/or containers running in a cloud platform. The receiving unit 210 is configured to receive a service message including a target identifier set to a value indicating that any UE 15 is targeted by the service request or notification and a scope indication to be applied to the target identifier. The scope indication comprises a matching criteria linked to a context parameter stored by the network node as part of a UE-specific context. The determining unit is configured to determine, for each of one or more UEs 15 served by the network node 200, whether the UE 15 is a target UE by comparing the scope indication in the service request or notification to the linked context parameter stored as part of the UE-specific context. The providing unit 130 is configured to provide a service for one or more of the target UEs 15 based on an indication from the determining unit.

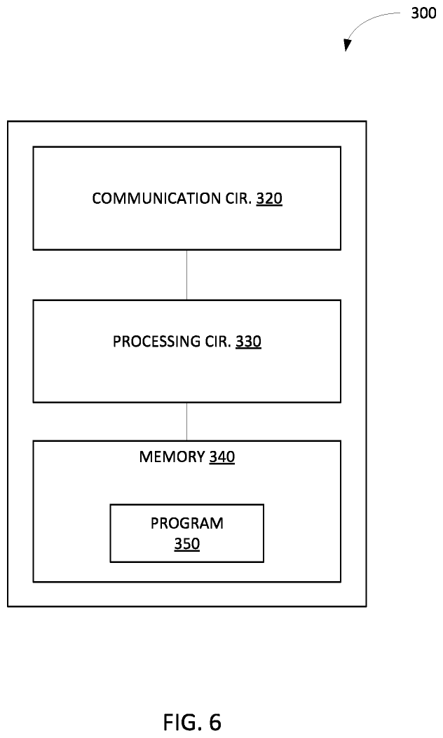

FIG. 6 illustrates an exemplary network node 300 in a wireless communication network 10 configured to operate as herein described. The network node 300 may, for example, comprise an AMF 40, SMF 45 or other NF that stores a UE-specific context. The network node 300 generally comprises communication circuitry 320 for communicating with network devices over a communication network, processing circuitry 330 for controlling the operation of the workload scheduler 300 and memory 340 for storing programs and data needed by the data analytics component.

The communication circuitry 320 couples the network node 300 to a communication network for communication with other network devices to manage cloud resources in the cloud RAN 100 and to receiving scheduling requests from network operators. The communication circuitry 320 may comprise a wired or wireless interface operating according to any standard, such as the Ethernet, Wireless Fidelity (WiFi) and Synchronous Optical Networking (SONET) standards.

The processing circuitry 330 controls the overall operation of the network node 300. The processing circuitry 330 may comprise one or more microprocessors, hardware, firmware, or a combination thereof. The processing circuitry 330 is configured to perform the functions of the network node 300 as herein described. In one embodiment, the network node 300 receive a service request or notification including a target identifier set to a value indicating that any UE is targeted by the service request or notification and a scope indication to be applied to the target identifier. The scope indication comprises a matching criteria linked to a UE context parameter stored by the network node as part of a UE context. The processing circuitry 330 is further configured to determine, for each of one or more UEs served by the network node, whether the UE is a target UE by comparing the scope indication in the service request or notification to the linked UE context parameter stored as part of the UE context. The processing circuitry 330 is further configured to provide a service for one or more of the target UEs.

Memory 340 comprises both volatile and non-volatile memory for storing computer program code and data needed by the processing circuitry 330 for operation. Memory 340 may comprise any tangible, non-transitory computer-readable storage medium for storing data including electronic, magnetic, optical, electromagnetic, or semiconductor data storage. Memory 340 stores computer program 350 comprising executable instructions that configure the processing circuitry 330 to implement the methods herein described. A computer program 350 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 350 for configuring the processing circuitry 330 as herein described may be stored in a removable memory, such as a portable compact disc, portable digital video disc, or other removable media. The computer program 350 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

1-25. (canceled)

26. A method implemented by a network node in a wireless communication network, the method comprising:
receiving a service message including a target identifier set to a value indicating that any UE is targeted by a service request or notification comprised in the service message, and a scope indication to be applied to the target identifier, the scope indication comprising a matching criteria linked to a context parameter stored by the network node as part of a UE-specific context; and
determining, for each of one or more UEs served by the network node, whether the UE is a target UE by comparing the scope indication to the linked context parameter; and
based on the determining, providing a service for one or more of the target UEs.

27. The method of claim 26, wherein receiving the service message comprises receiving a subscription request for event notifications related to one or more events for the target UEs.

28. The method of claim 27, wherein determining, for each of one or more UEs, whether the UE is a target UE is performed responsive to detection of an event specified by the subscription request.

29. The method of claim 28, wherein providing the service for one or more of the target UEs comprises sending an event notification responsive the detection of the event specified by the subscription request.

30. The method of claim 26, wherein receiving the service message comprises receiving a notification indicating that a configuration parameter for one or more UEs served by the network node has been changed.

31. The method of claim 30, wherein determining, for each of one or more UEs, whether the UE is a target UE is performed responsive to the notification.

32. The method of claim 28, wherein providing the service for one or more of the matching UEs comprises updating a configuration of one or more of the target UEs based on the configuration parameter.

33. The method of claim 32, wherein:
the configuration parameter comprises a behavior parameter; and
updating the configuration comprises updating a behavior configuration for the one or more target UEs.

34. The method of claim 32, wherein:
the configuration parameter comprises a network configuration parameter; and
updating the configuration comprises updating a network configuration for the one or more target UEs.

35. The method of claim 26, wherein the scope indication comprises an identifier of an equipment provider.

36. The method of claim 35, wherein determining, for each of one or more UEs served by the network node, whether the UE is a target UE comprises determining whether the equipment provider identifier provided in the scope indication matches equipment provider information stored in the UE context.

37. A network node in a wireless communication network, the network node comprising:
communication circuitry configured to enable communication with other network nodes in the wireless communication network;
processing circuitry configured to:
receive a service message including a target identifier set to a value indicating that any UE is targeted by a service request or notification comprised in the service message and a scope indication to be applied to the target identifier, the scope indication comprising a matching criteria linked to a context parameter stored by the network node as part of a UE-specific context for a UE; and
determine, for each of one or more UEs served by the network node, whether the UE is a target UE by comparing the scope indication to the linked context parameter; and
based on the determining, provide a service for one or more of the target UEs.

38. A method implemented by an application function server for requesting a service from a wireless communication network, the method comprising:
sending a request for a service to a network node of the wireless communication network, the request including a target identifier set to a value indicating that any UE is targeted by the requested service;
the request further including a scope indication to be applied to the target identifier, the scope indication comprising a matching criteria linked to a context parameter stored by the network node as part of a UE-specific context; and
thereby initiating the network node to provide the requested service for one or more target UEs served by the network node, the one or more target UEs being determined by comparing the scope indication to the linked context parameter.

39. The method of claim 38, wherein the requested service is a subscription request for event notifications related to one or more events for the target UEs.

40. The method of claim 38, wherein the requested service comprises a notification indicating that a configuration parameter for the target UEs has been changed, thereby initiating updating a configuration of one or more of the target UEs based on the configuration parameter.

41. The method of claim 40, wherein the configuration parameter comprises a behavior parameter or a network configuration parameter.

42. The method of claim 38, wherein the scope indication comprises an identifier of an equipment provider.
